(19) United States
(12) Patent Application Publication
(10) Pub. No.: US 2006/0288699 A1
(43) Pub. Date: Dec. 28, 2006

(54) Energy recovery system for rubber and plastic molding machines

(76) Inventor: Bradford G. Corbett JR., Fort Worth, TX (US)

Correspondence Address: WHITAKER, CHALK, SWINDLE & SAWYER, LLP, 3500 CITY CENTER TOWER II, 301 COMMERCE STREET, FORT WORTH, TX, 76102-4186, US

(21) Appl. No.: 11/472,147

(22) Filed: Jun. 21, 2006

Related U.S. Application Data
(60) Provisional application No. 60/693,389, filed on Jun. 23, 2005.

(51) Int. Cl. F02G 1/04; F01B 29/10

(52) U.S. Cl. 60/520

(57) ABSTRACT

An energy recovery system for a compression or injection molding operation is shown. A Stirling engine cycle is used to recover heat. The Stirling engine is driven by waste heat from the mold members or other associated parts of the injection or compression molding apparatus.

### CROSS REFERENCE TO RELATED APPLICATIONS

The present application claims priority from the following U.S. Provisional Application Ser. No. 60/693,389, filed Jun. 23, 2005, entitled “Energy Recovery System for Rubber and Plastic Molding Machines,” and invented by Bradford G. Corbett, Jr.

### BACKGROUND OF THE INVENTION

1. Field of the Invention

The present invention relates generally to injection and compression molding processes, to the equipment for forming rubber and plastic articles using compression and injection molding techniques and to a process for recovering waste energy from such processes.

2. Description of the Prior Art

An almost unlimited variety of articles are produced from rubber, synthetic elastomers and plastics using compression and injection molding equipment. As one example, many kinds of equipment, ducting, piping, castings, and other parts are joined together in gasketed joints in order to form gas, liquid, electrical, chemical, or sound isolation seals at the joints.

For example, a variety of piping systems are known for the conveyance of fluids which employ elastomeric type sealing rings or gaskets. The pipes used in such systems may be formed of PVC, polyolefins such as PE and PP, ductile iron, concrete, clay, fiberglass, steel, cast iron, fiberglass/cement reinforced pipes and such metals as aluminum and copper. Pipes formed from thermoplastic materials including polyethylene and PVC are used in a variety of industries but are particularly useful in municipal water and sewage systems. In forming a joint between thermoplastic sections of pipe, the spigot or male pipe end is inserted within the female or socket pipe end. An annular, elastomeric ring or gasket is typically seated within a groove formed in the socket end of the thermoplastic pipe. As the spigot is inserted within the socket, the gasket provides the major seal capacity for the joint.

The elastomeric rings or gaskets used in the above type of sealing applications are typically formed from natural or synthetic rubbers or synthetic elastomers in compression or injection molding machines. Despite the many advances which have occurred in injection and compression molding technologies, a need exists to continue to improve the manufacturing efficiency and economy. A specific area in which the overall efficiency and economy of the process can be improved is in the area of energy utilization and recovery.

Both profits and environmental quality can be improved by more carefully using energy in industrial processes such as the compression and injection molding processes described. Discharging any heated fluid (air, water, etc.) into the environment is a waste of money and resources. Hot waste streams are paid for with money that could have been profit. Energy has always been a significant component of industrial operations, but only rarely has efficient energy use been a priority when factories were being expanded. As long as a factory or product line was profitable, very little attention was usually paid to efficient energy use. Today, however, increasing attention is being focused on maximizing energy use and minimizing pollution in the modern industrial setting.

### SUMMARY OF THE INVENTION

The present method utilizes a Stirling engine thermodynamic cycle in order to utilize the waste heat which is generated in an injection or compression molding operation. In the case of a compression molding process, a molding material is placed in a cavity having a predetermined shape, the cavity being formed between a fixed mold member and a movable mold member. The molding material is a natural or synthetic rubber or any one of a number of synthetic elastomers. Pressure is applied between the respective fixed and movable mold members to cause the mold material to conform to the shape of the mold cavity. In the method of the invention, Stirling engine is positioned in proximity to the fixed and movable mold members, the Stirling engine having a heating cycle and a cooling cycle which alternately heat and cool a fixed volume of compressible gas. The natural heating changes which occur in the operation of the molding process are used to power the Stirling engine.

In one embodiment of the invention, the Stirling engine has a first and second cylinders, the first cylinder being heated by an external heat source associated with the molding process and the second cylinder being cooled by an external cooling source. In one embodiment of the invention, the mold cavity is in a shape which is suitable for forming a sealing gasket when the fixed and movable mold members are brought into contact.

In another embodiment of the invention, a Stirling engine is used to recover energy in an injection molding process. In the injection molding process, a molding material is fed from a hopper into a working chamber where it is softened by heat in a heated region and then forced into a mold of a desired shape where it is cooled and solidified in a cooling region. As previously described, a Stirling engine is placed in proximity to the injection molding apparatus. The Stirling engine has a heating cycle and a cooling cycle which alternately heat and cool a fixed volume of compressible gas. The method of the invention uses heating changes which occur as a result of operation of the molding process to power the Stirling engine.

Additional objects, features and advantages will be apparent in the written description which follows.

### BRIEF DESCRIPTION OF THE DRAWINGS

FIGS. 1a-1d depict the principle of operation of a prior art Stirling cycle machine;

FIG. 2 is a pressure-volume diagram of the Stirling cycle shown in FIGS. 1a-1d;

FIG. 3 is a temperature-entropy diagram of the Stirling cycle shown in FIGS. 1a-1d;

FIGS. 4a-4d are simplified, schematic illustrations of a Stirling cycle which is used to recover energy and convert the energy to mechanical work;

FIGS. 5a-5b are simplified illustrations of the steps involved in a compression molding process in which a Stirling engine is used to recover energy from the process; and

FIG. 6 is a simplified view of an injection molding apparatus with a Stirling engine being used to recover energy from the process.

### DETAILED DESCRIPTION OF THE INVENTION

The present invention involves the use of s Stirling engine or Stirling cycle in recovering heat from an injection molding or compression molding process. Since Stirling engines can run on any heat source, they can be used to recover power from industrial waste heat sources such as those found in compression and injection molding industries. Stirling cycle machines, including engines and refrigerators, are well known in the art. Many technical articles and treatises have been written on the subject. For example, see the text by G. Walker, “Stirling Engines”, Clarendon Press, Oxford, 1980, ISBN No. 0-19-856209-8, which is considered by many to be a standard reference in the field.

Briefly stated, the principle underlying the Stirling cycle engine is the mechanical realization of the Stirling thermodynamic cycle: isovolumetric heating of a gas within a cylinder, isothermal expansion of the gas (during which work is performed by driving a piston), isovolumetric cooling, and isothermal compression. The Stirling cycle refrigerator is also the mechanical realization of a thermodynamic cycle which approximates the ideal Stirling thermodynamic cycle. In an ideal Stirling thermodynamic cycle, the working fluid undergoes successive cycles of isovolumetric heating, isothermal expansion, isovolumetric cooling and isothermal compression. Practical realizations of the cycle, wherein the stages are neither isovolumetric nor isothermal, are intended to be within the scope of the present invention, as will be described in the examples which follow.

In more practical terms, every Stirling engine has a sealed cylinder with one part hot and the other cold. The working gas inside the engine (which is often air, helium, or hydrogen) is moved by a mechanism from the hot side to the cold side. When the gas is on the hot side it expands and pushes up on a piston. When it moves back to the cold side it contracts. Properly designed Stirling engines have two power pulses per revolution, which can make them very smooth running. Two of the more common types are two piston Stirling engines and displacer-type Stirling engines. The two piston type Stirling engine has two power pistons. The displacer type Stirling engine has one power piston and a displacer piston.

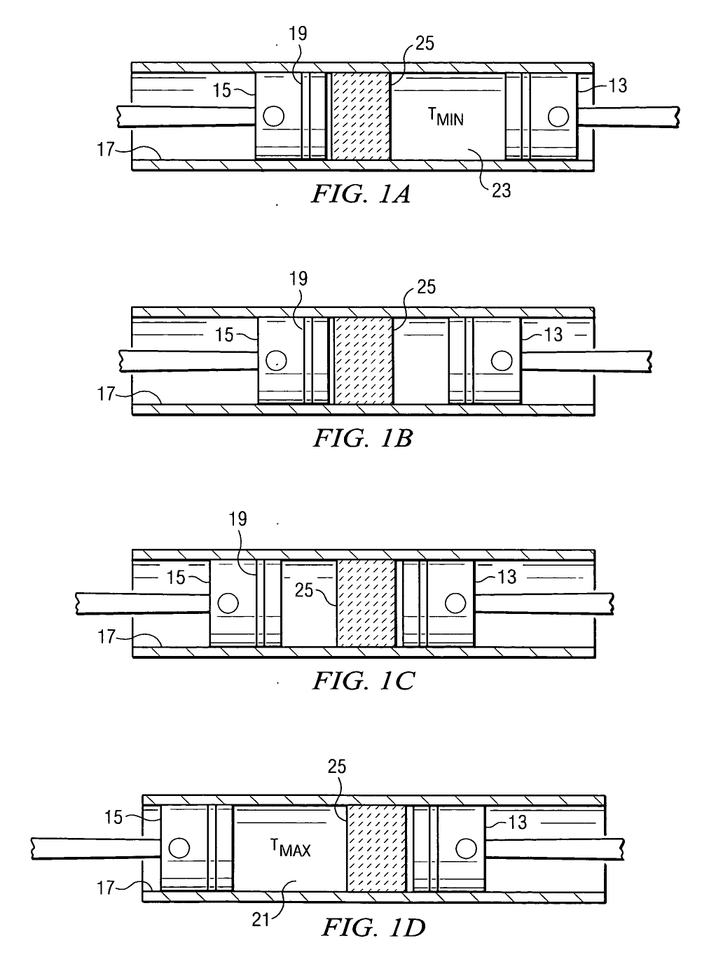

Turning now to FIGS. 1a-1d of the drawings, the principle of operation of a Stirling cycle engine is described. It will be understood by those skilled in the art, however, that many mechanical versions of the Stirling cycle engines are known in the art, and the particular Stirling cycle illustrated in the Figures is shown merely for illustrative purposes. In FIGS. 1a to 1d, a piston 13 (otherwise referred to herein as a “compression piston”) and a second piston (also known as an “expansion piston”) 15 move in phased reciprocating motion within cylinder 17. Compression piston 13 and expansion piston 15 may also move within separate, interconnected, cylinders. Piston seals 19 prevents the flow of a working fluid contained within cylinder 17 between piston 13 and piston 15 from escaping around either piston. The working fluid is chosen for its thermodynamic properties, and can be, for example, helium at a pressure of several atmospheres. The volume of fluid governed by the position of expansion piston 15 is referred to as expansion space (21 in FIG. 1d). The volume of fluid governed by the position of compression piston 13 is referred to as compression space 23 (FIG. 1a). In order for fluid to flow between expansion space 21 and compression space 23, the fluid passes through regenerator 25. In the particular embodiment of the invention illustrated, the regenerator 25 is a matrix of material having a large ratio of surface area to volume which serves to absorb heat from the working fluid when the fluid enters hot from expansion space 21 and to heat the fluid when it passes from compression space 23 returning to expansion space 21.

During the first phase of the engine cycle, the starting condition of which is depicted in FIG. 1a, piston 13 compresses the fluid in compression space 23. The compression occurs at a constant temperature because heat is extracted from the fluid to the ambient environment. In practice, a cooler is typically provided, as will be discussed in the description below. The condition of the engine after compression is depicted in FIG. 1b. During the second phase of the cycle, expansion piston 15 moves in synchrony with compression piston 13 to maintain a constant volume of fluid. As the fluid is transferred to expansion space 21, it flows through regenerator 25 and acquires heat from regenerator 25 such that the pressure of the fluid increases. At the end of the transfer phase, the fluid is at a higher pressure and is contained within expansion space 21, as depicted in FIG. 1c.

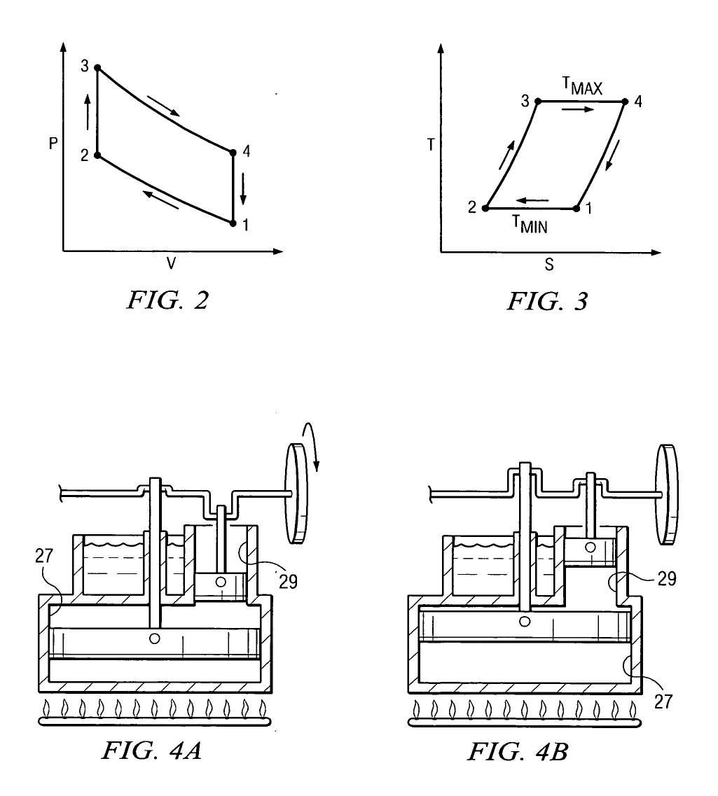

During the third (expansion) phase of the engine cycle, the volume of expansion space 21 increases as heat is drawn in from outside the engine, thereby converting heat to work. In practice, heat is provided to the fluid in expansion space 21 by means of a heater 64, as will be further described. At the end of the expansion phase, the hot fluid fills the full expansion space 21 as depicted in FIG. 1d. During the fourth phase of the engine cycle, the fluid is transferred from expansion space 21 to compression space 23, heating regenerator 25 as the fluid passes through it. At the end of the second transfer phase, the fluid is in compression space 23, as depicted in FIG. 1a, and is ready for a repetition of the compression phase. The Stirling cycle is depicted in a P-V (pressure-volume) diagram as shown in FIG. 2 and in a T-S (temperature-entropy) diagram as shown in FIG. 3. The Stirling cycle is a closed cycle in that the working fluid is typically not replaced during the course of the cycle.

The principle of operation of a Stirling cycle refrigerator can also be described with reference to FIGS. 1a-1d, wherein identical numerals are used to identify the same or similar partsThe differences between the engine described above and a Stirling machine employed as a refrigerator are that compression volume 21 is typically in thermal communication with ambient temperature and expansion volume 23 is connected to an external cooling load (not shown).

One key characteristic of the Stirling engine is that a fixed amount of a gas is sealed inside the engine. The Stirling cycle involves a series of events that change the pressure of the gas inside the engine, causing it to do work. There are several properties of gasses that are critical to the operation of Stirling engines: (1) if you have a fixed amount of gas in a fixed volume of space and you raise the temperature of that gas, the pressure will increase; (2) if you have a fixed amount of gas and you compress it (decrease the volume of its space), the temperature of that gas will increase.

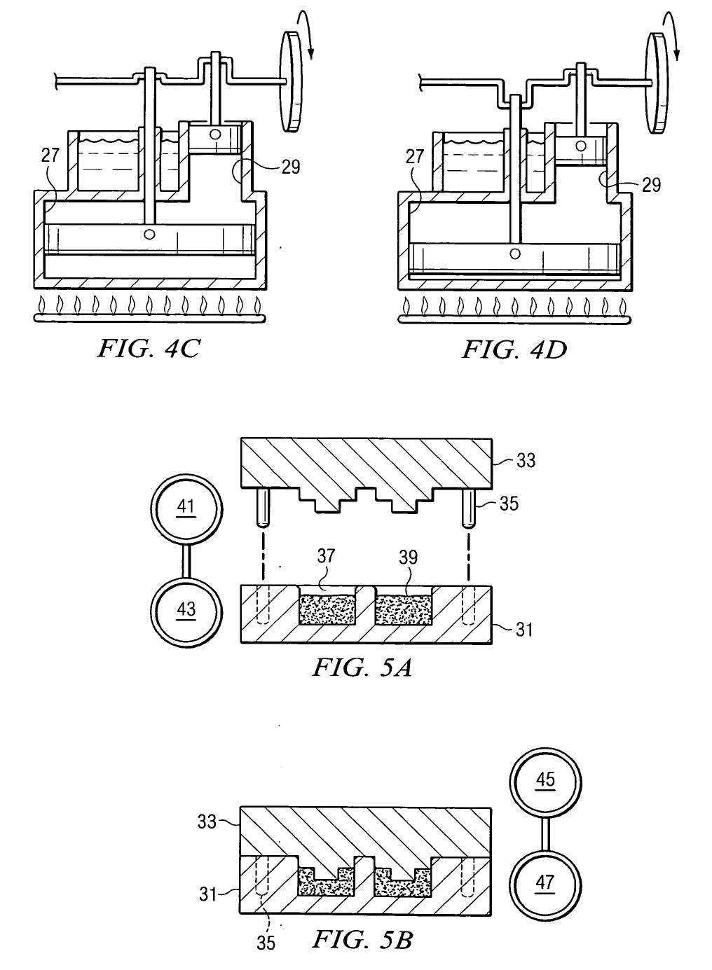

Referring now to the simplified depiction of a Stirling cycle in FIGS. 4a-4d of the drawings, each part of the Stirling cycle will be described while looking at a simplified Stirling engine. In this case, the simplified engine uses two cylinders shown generally as 27 and 29 in FIG. 4a. One cylinder is heated by an external heat source (such as fire), and the other is cooled by an external cooling source (such as ice). The gas chambers of the two cylinders are connected, and the pistons are connected to each other mechanically by a linkage that determines how they will move in relation to one another

There are basically four parts to the Stirling cycle as illustrated in FIGS. 4a-4d. The two pistons 27, 29 accomplish the parts of the cycle in the following manner. Heat is added to the gas inside the heated cylinder 27, causing pressure to build. This forces the piston to move down. This is the part of the Stirling cycle that is used to accomplish work. The left piston 27 moves up while the right piston 29 moves down. This pushes the hot gas into the cooled cylinder, which quickly cools the gas to the temperature of the cooling source, lowering its pressure. It is then easier to compress the gas in the next part of the cycle.

The piston in the cooled cylinder 29 starts to compress the gas. Heat generated by this compression is removed by the cooling source. The right piston 29 moves up while the left piston 27 moves down. This forces the gas into the heated cylinder, where it quickly heats up, building pressure, at which point the cycle repeats.

The Stirling engine only creates power during the first part of the cycle. There are two main ways to increase the power output of a Stirling cycle:

1. Increase power output in stage one—In part one of the cycle, the pressure of the heated gas pushing against the piston performs work. Increasing the pressure during this part of the cycle will increase the power output of the engine. One way of increasing the pressure is by increasing the temperature of the gas. The two-piston Stirling engine described above in relation to FIGS. 1a-1d uses a regenerator to improve the power output of the engine by temporarily storing heat.

2. Decrease power usage in stage three—In part three of the cycle, the pistons perform work on the gas, using some of the power produced in part one. Lowering the pressure during this part of the cycle can decrease the power used during this stage of the cycle (effectively increasing the power output of the engine). One way to decrease the pressure is to cool the gas to a lower temperature.

This section described the ideal Stirling cycle. Actual working engines vary the cycle slightly because of the physical limitations of their design.

Turning now to FIGS. 5a and 5b, a compression molding machine is illustrated in simplified, schematic fashion. The device shown in FIG. 5a includes a fixed mold element 31 and a movable mold element 33. The mold elements are moved in reciprocal fashion, as illustrated in FIGS. 5a and 5b by means of a prime mover (illustrated schematically as 35 in FIGS. 5a and 5b). In this case, the lower, fixed mold element 31 has a mold cavity 37 which contains a molding material 39 such as a suitable natural or synthetic rubber or other suitable synthetic elastomer. The cavity 37 has a predetermined shape, such as that of a sealing ring or gasket. As shown in FIGS. 5a and 5b, pressure is applied between the respective fixed and movable mold members to cause the mold material 37 to conform to the shape of the mold cavity.

In the embodiment of the invention illustrated in FIGS. 5a and 5b, the working ends or chambers 41, 43 and 45, 47, respectively, are positioned proximate the fixed and movable mold members 31, 33. The Stirling engine has a heating cycle and a cooling cycle which alternately heats and cools a fixed volume of compressible gas, as previously described. The method of the invention thus uses the heating changes which occur as a result of operation of the molding process to power the Stirling engine.

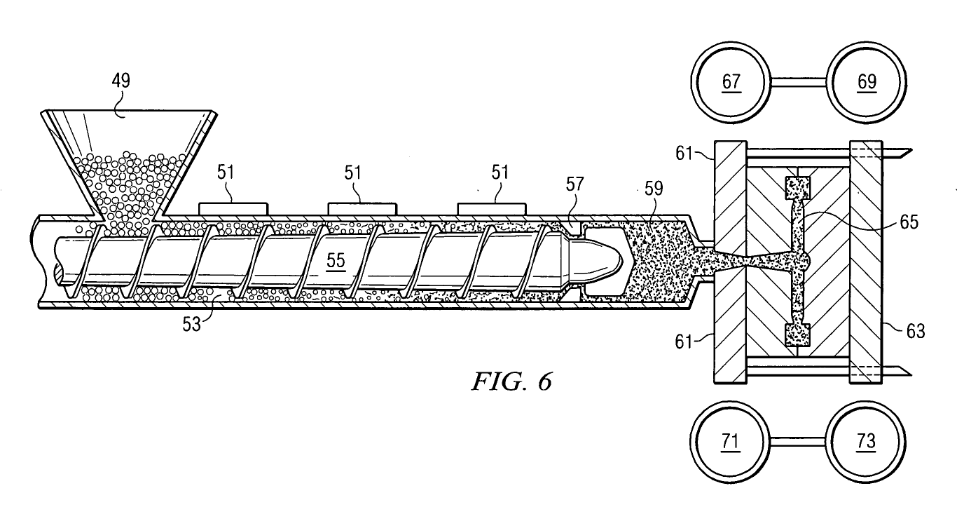

FIG. 6 illustrates the principles of the invention in the case of an injection molding operation. In the injection molding operation illustrated in FIG. 6, polymer granules are fed to a hopper 49. In the particular embodiment illustrated, electric heaters 51 surround the working chamber 53 in which is located a screw of decreasing channel depth 55. The screw 55 acts as a melting plasticizer and ram for injecting the heated polymer. A check valve 57 prevents backflow during the injection operation. A reservoir of the melt 59 is thereby accumulated for each “shot” of injected plastic. The injection molding apparatus further includes a fixed platen 61 and a movable platen 63. The fixed and movable platens 61, 63 define a mold region 65 of a desired shape where the injected plastic is cooled and solidified in a cooling region.

As shown in FIG. 6, a Stirling engine having regions or chambers 67, 69 and 71, 73 is located in proximity to the platens 61, 63 used in the injection molding process. The Stirling engine has a heating cycle and a cooling cycle which alternately heats and cools a fixed volume of compressible gas. The method of the invention uses heating changes which occur as a result of operation of the molding process to power the Stirling engine. Note that the Stirling engine may or may not be physically coupled to a selected one of the fixed and movable platens. In certain molding operations, the mold members will heat up in the range of 500 degrees F., or above, Thus, in some embodiments of the invention, the components are physically separated from the platens with heat exchange being by convection through the surrounding air. In other embodiments, one or the other of the platens is placed in contact with the Stirling engine with heat exchange being effected by conduction through connecting surfaces.

An invention has been provided with several advantages. The energy recovery system of the invention utilizes the cycle of a Stirling engine to effectively recover energy from an injection or compression molding operation. The energy which is recovered can be used to power the injection or compression molding operation or parts thereof, or can be utilized in another part of the manufacturing plant. It is not necessary to physically connect the Stirling engine to the components of the injection or compression molding apparatus, since heat transfer to the Stirling engine can be accomplished by convection. As a result, extensive changes to the existing equipment in the plant is not required.

While the invention has been shown in only one of its forms, it is not thus limited but is susceptible to various changes and modifications without departing from the spirit thereof.

What is claimed is:

1. A method of recovering energy in a compression molding process in which a molding material is placed in a cavity having a predetermined shape, the cavity being formed between a fixed mold member and a movable mold member, pressure being applied between the respective fixed and movable mold members to cause the mold material to conform to the shape of the mold cavity, the method comprising the steps of:
positioning a Stirling engine in proximity to the fixed and movable mold members, the Stirling engine having a heating cycle and a cooling cycle which alternately heat and cool a fixed volume of compressible gas;
using heating changes which occur as a result of operation of the molding process to power the Stirling engine.

2. The method of claim 1, wherein the Stirling engine has a first and second cylinders, the first cylinder being heated by an external heat source associated with the molding process and the second cylinder being cooled by an external cooling source.

3. The method of claim 2, wherein each cylinder has a gas chamber, the gas chambers being interconnected by means of a mechanical linkage.

4. The method of claim 1, wherein the molding material is selected from the group consisting of natural and synthetic rubbers and synthetic elastomers.

5. The method of claim 1, wherein the mold cavity is in the shaped to form a sealing gasket when the fixed and movable mold members are brought into contact.

6. A method of recovering energy in an injection molding process in which a molding material is fed from a hopper into a cylinder where it is softened by heat in a heated region and then forced into a mold of a desired shape where it is cooled and solidified in a cooling region, the method comprising the steps of:
positioning a Stirling engine in proximity to the injection molding process, the Stirling engine having a heating cycle and a cooling cycle which alternately heat and cool a fixed volume of compressible gas;
using heating changes which occur as a result of operation of the molding process to power the Stirling engine.

7. The method of claim 6, wherein the Stirling engine has a first and second cylinders, the first cylinder being heated by an external heat source associated with the molding process and the second cylinder being cooled by an external cooling source.

8. The method of claim 7, wherein each cylinder has a gas chamber, the gas chambers being interconnected by means of a mechanical linkage.

9. The method of claim 6, wherein the molding material is selected from the group consisting of natural and synthetic rubbers and synthetic elastomers.

10. The method of claim 6, wherein the mold cavity is in the shaped to form a sealing gasket when the fixed and movable mold members are brought into contact.
